(19) United States
(12) Patent Application Publication
(10) Pub. No.: US 2002/0050718 A1
(43) Pub. Date: May 2, 2002

(54) Compression fitting for threadless conduit

(75) Inventor: Roger D. Pyron, Bartlett, TN (US)

Correspondence Address: Rohini K. Garg, HOFFMANN & BARON, LLP, 6900 Jericho Turnpike, Syosset, NY, 11791, US

(73) Assignee: Thomas & Betts International, Inc.

(21) Appl. No.: 09/955,752

(22) Filed: Sep. 19, 2001

Related U.S. Application Data
(60) Provisional application No. 60/234,437, filed on Sep. 21, 2000.

(51) Int. Cl. F16L 33/18; F16L 19/00

(52) U.S. Cl. 285/354; 285/340

(57) ABSTRACT

An improved compression conduit fitting to be attachable to threadless conduit. The conduit fitting includes a generally cylindrical body with a longitudinal internal bore extending therethrough. The body has an externally threaded conduit receiving end and an externally threaded conductor egressing end located opposite the receiving end. A gasket of annular shape is placed within the internal bore of the body. Moreover, an internally threaded gland nut of annular shape is slideably positioned over the conduit to be securely attached to the body. Finally, a compression ring of annular shape is interposed between the gland nut and the body to compresses one end of the conduit against the gasket, thereby forming a liquid tight seal.

### FIELD OF THE INVENTION

The present invention relates generally to a compression fitting for rigid conduit. More particularly, the present invention relates to a compression fitting used to form a water resistant seal at the end of a rigid conduit.

### BACKGROUND OF THE INVENTION

It has been long known to use fittings to terminate the end of a rigid conduit which contains electrical wires and cables. The fitting is typically attached to the end of the conduit, and the electrical wires extending through the conduit extend externally of the fitting for electrical termination. The fitting itself may be attached to various components such as conduit hubs, electrical panels or the like in order to provide mechanical and electrical termination of the conduit and the wire extending therethrough.

Compression fittings typically include an elongate fitting body which may be externally threaded at both ends. A compression ring may be supported about the end of the rigid conduit. A gland nut is positionable over the conduit and attachable to one threaded end of the fitting body to secure the conduit to the body. During the securement of the gland nut onto the fitting body, the compression ring compresses about the conduit, effecting secure mechanical engagement of the conduit within the fitting. The tight compressive engagement of the compression ring also serves to maintain some degree of water resistance, preventing water from tracking from outside the conduit and fitting to within the fitting which would potentially adversely effect the electrical wires and terminations made therein.

Recent changes in applicable standards, such as those promulgated by Underwriters Laboratories, has resulted in a more stringent requirement for water resistance. Previously, the conduit fittings of the prior art have been “raintight”, that is, no appreciable water was allowed to pass through the fitting. The more stringent standards require the fitting to be essentially water tight, that is, to prevent all water passage through the connection.

It is, therefore, desireable to provide a conduit fitting which meets the more stringent “raintight” standards.

### SUMMARY OF THE INVENTION

It is an object of the present invention to provide a conduit fitting which meets the more stringent “raintight” standards by providing a watertight seal not only around and about the conduit but also at the end of the conduit.

Therefore, the present invention provides an improved compression conduit fitting for threadless conduit. The conduit fitting comprises a generally cylindrical body with a longitudinal internal bore extending therethrough. The body has an externally threaded conduit receiving end and an externally threaded conductor egressing end located opposite the receiving end. A gasket of annular shape is placed within the internal bore of the body. Moreover, an internally threaded gland nut of annular shape is slideably positioned over the conduit to be securely attached to the body. Finally, a compression ring of annular shape is interposed between the gland nut and the body to compress one end of the conduit against the gasket, thereby forming a liquid tight seal.

### BRIEF DESCRIPTION OF DRAWINGS

FIG. 1 is an exploded perspective view of a conduit and conduit fitting of the present invention.

FIG. 2 is a longitudinal section of the assembled conduit and fitting of the present invention.

### DETAILED DESCRIPTION OF THE PREFERRED EMBODIMENT

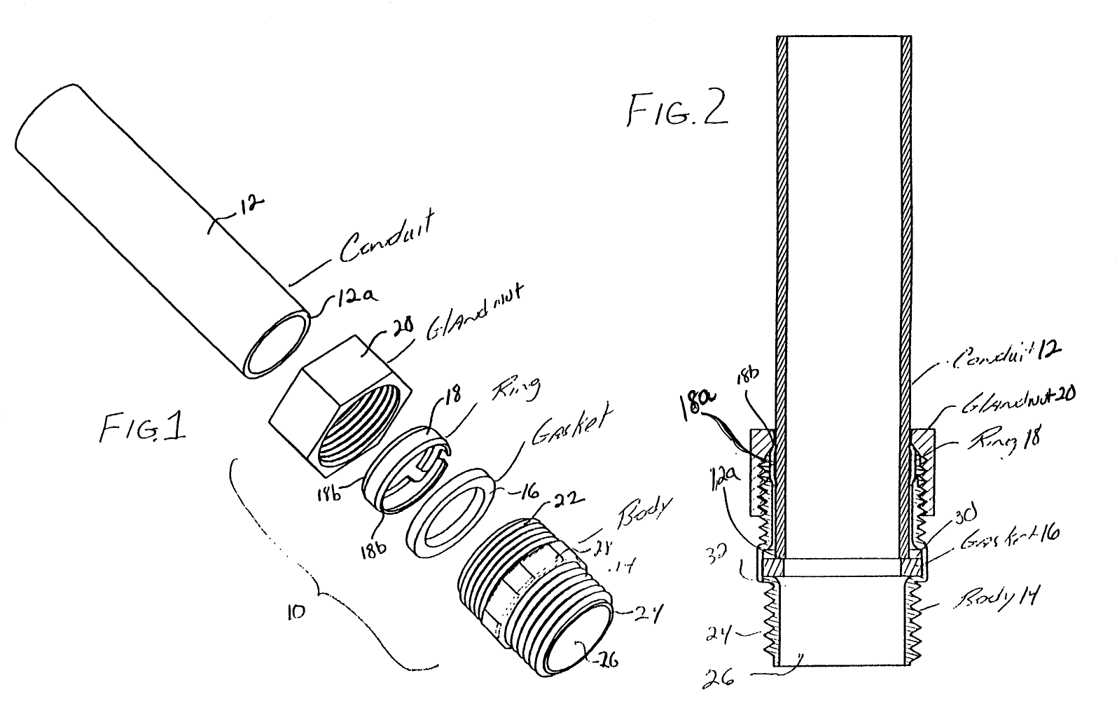

Referring now to the drawings and particularly to FIG. 1, there is shown an exploded view of conduit 12 and the conduit fitting 10. The conduit fitting 10 may be used to terminate an electrical conduit 12.

Conduit 12 is an elongate tubular member used to contain a plurality of electrical cables (not shown) therein. The conduit is used to run the cable over a longitudinal expanse so as to protect the cables within the conduit. Conduits of this type are well known in the art and may be formed of a variety of materials including rigid plastic and metal. Conduit 12 is an elongate tubular member having a first end 12a through which the electrical cables would extend.

Conduit fitting 10 of the present invention includes a fitting body 14, a gasket 16, a compression ring 18 and a gland nut 20.

Fitting body 14 is an elongate, generally cylindrical member typically formed of metal. However, the body may be comprised of materials which are non-metallic such as ceramic, plastic or composites which include such materials. The fitting body 14 also has a first externally threaded conduit receiving end 22 and an opposed externally threaded conductor egressing end 24. A longitudinal bore 26 extends therethrough bounding the fitting body 14. An external surface 28 of fitting body 14 may include a plurality of flat surfaces therearound which enable the fitting body to be gripped by an appropriate tool to facilitate tightening of the gland nut 20 onto body 14 and the securement of body 14 to an external component such as an electrical panel.

Gland nut 20 is a generally annular member which is internally threaded for telescopic screw attachment to end 22 of body 14. Gland nut 20 also includes a plurality of flat surfaces about the external surface thereof to facilitate securement of the gland nut 20 onto the body 14.

Interposed between gland nut 20 and body 14 is compression ring 18. Compression ring 18 is a split annular member typically formed of metal. In cross-section, as shown in FIG. 2, compression ring 18 has a flat surface 18a and a pair of oppositely directed depending edges 18b. Compression ring 18 is designed to fit about the exterior surface of conduit 12 where the split nature of ring 18 allows it to be tightened thereabout. Depending fingers 18b enable the ring to tightly grip about the exterior surface of conduit 12.

Gasket 16 is supported within the internal bore 26 of body 14. Gasket 16 is an annular member formed of a suitable, resiliently compressible elastomer. Gasket 16 has an outer diameter which is substantially greater than the outer diameter of conduit 12, and an inner diameter which is less than the outer diameter of conduit 12. As shown in FIG. 2, this allows the end 12a of conduit 12 to be bottomly positioned against the gasket 16 when the conduit 12 is terminated within fitting 10.

Referring now more particularly to FIG. 2, the assembly of fitting 10 and its termination to the conduit 12 is described.

Gland nut 20 is slideably positioned over the conduit 12. The split compression ring 18 may be next positioned over the end of conduit 12a for captive receipt within gland nut 20. Gasket 16 is then positioned within bore 26 of body 14, and is resident within an annular chamber 30, centrally located between ends 22 and 24. Gasket 16 is positioned against a forward shoulder 32 formed adjacent end 24. The forward shoulder forms a seat for gasket 16. With the gland nut 20 and compression ring 18 positioned about conduit 12, and the gasket positioned within body 14, end 12a of conduit 12 is inserted into the conduit receiving end 22 of body 14. The conduit is inserted until the end 12a loosely abuts the gasket 16 held within a chamber 30 of the body 14. The gland nut 20 may then be screw attached to the end 22 of body 14 to secure the gland nut 20 to the body 14. Upon screw engagement of gland nut 20 onto body 14, the gland nut will telescopically progress along the length of the conduit 12. As the compression ring 18 grasps the outer surface of the conduit 12, it will drive the conduit 12 forward within the body 14. The end of conduit 12a will compressively abut against gasket 16, which is held against a forward shoulder 32 of the body 14, thereby compressing the gasket 16 and forming a watertight seal thereat.

Thus, in addition to the water resistant seal provided by the compression ring 18 about conduit 12, the present invention also provides a watertight seal at the end of conduit 12a by providing a gasket between the end of the conduit and the shoulder 32 of body 14, thereby providing a very secure liquid resistant seal.

While the invention has been described by the foregoing detailed description in relation to the preferred embodiments, it will be understood by those skilled in the art that various changes may be made without deviating from the spirit and scope of the invention.

What is claimed is:

1. A compression conduit fitting for a threadless conduit comprising:
a generally cylindrical body with a longitudinal internal bore extending therethrough, the body having a conduit receiving end and a conductor egressing end located opposite the receiving end;
a gasket of annular shape supported within the internal bore of the body;
a gland nut of annular shape slideably positioned over the conduit for telescopic attachment to the receiving end of the body; and
a compression ring of annular shape interposed between the gland nut and the body, said compression ring compressing one end of the conduit against the gasket upon said telescopic attachment, thereby forming a liquid tight seal.

2. The compression conduit fitting of claim 1 wherein the compression ring is positioned over the end of the conduit for captive receipt within the gland nut.

3. The compression conduit fitting of claim 1, wherein the compression ring includes a flat surface with a pair of oppositely directed depending edges for tightly griping the conduit.

4. The compression conduit fitting of claim 1 wherein the body further includes an annular chamber centrally located between the receiving end and the egressing end of the body.

5. The compression conduit fitting of claim 4 wherein the gasket is positionable within the annular chamber of the body.

6. The compression conduit fitting of claim 1, wherein the body further includes a forward shoulder formed adjacent to the egressing end.

7. The compressing conduit fitting of claim 6 wherein the gasket is positionable against the forward shoulder of the body.

8. The compression conduit fitting of claim 1, wherein the end of the conduit is insertable into the receiving end of the body until the end of the conduit loosely adjoins the gasket and wherein said gland nut is screw attachable on to the receiving end of the body.

9. The compression conduit fitting of claim 1, wherein upon said telescopic attachment of said gland nut, the compression ring tightly grasps the conduit, driving the conduit forward within the body, thereby compressing the one end of the conduit against the gasket.

10. The compression conduit fitting of claim 1, wherein said conduit receiving end and said conductor egressing end of the body are externally threaded.

11. The compression conduit fitting of claim 1, wherein said gland nut is internally threaded.

12. The compression conduit fitting of claim 1, wherein said telescopic attachment includes screw attachment of said gland nut into said body.
